(19) United States
(12) Patent Application Publication
(10) Pub. No.: US 2010/0104767 A1
(43) Pub. Date: Apr. 29, 2010

(54) PRODUCTION METHOD FOR NANOCOMPOSITE MAGNET

(75) Inventors: Noritsugu Sskuma, Shizuoka-Ken (JP); Tetsuya Shoji, Shizuoka-Ken (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: TOYOTA JIDOSHA KABUSHIKI KAISHA, TOYOTA-SHI (JP)

(21) Appl. No.: 12/513,245

(22) PCT Filed: Nov. 1, 2007
(86) PCT No.: PCT/IB2007/004340

§ 371 Date: Jun. 30, 2009

(30) Foreign Application Priority Data
Nov. 1, 2006 (JP) 2006-297893

(51) Int. Cl. B05D 7/00; B05D 5/00; H05H 1/00

(52) U.S. Cl. 427/535; 427/127

(57) ABSTRACT

A nanocomposite magnet having a core-shell structure that includes a hard magnetic phase of an Nd₂Fe₁₄B compound as a core and a soft magnetic phase of Fe as a shell is produced by adding and dispersing particles of the Nd₂Fe₁₄B compound into a solvent that contains a surface-active agent, and then adding thereto an Fe precursor so as to cause Fe particles on the surface of the Nd₂Fe₁₄B compound, and drying and sintering the particles of the Nd₂Fe₁₄B compound.

### FIELD OF THE INVENTION

The invention relates to a production method for a nanocomposite magnet for use as a permanent magnet in various motors and the like.

### BACKGROUND OF THE INVENTION

Permanent magnets are used in a wide variety of fields, including electronics, information and communications, industrial and automotive electric motors, etc. With regard to the permanent magnets, further enhancement in performance and further reduction in size and weight are demanded. Presently, Nd₂Fe₁₄B compounds (neodymium magnets) are widely used as high-permeance magnets, and various proposals have been made for the purpose of further enhancement in performance.

One approach for such performance enhancement disclosed in Japanese Patent Application Publication No. 2003-59708 (JP-A-2003-59708) is development of a nanocomposite magnet in which a soft magnetic phase with high magnetization and a hard magnetic phase with high coercive force are uniformly distributed in the same metallic structure and the soft and hard magnetic phases are magnetically coupled due to an exchange interaction. To produce this nanocomposite magnet, a raw alloy melt is rapidly cooled to prepare a rapidly solidified alloy. After that, the rapidly solidified alloy is thermally treated to disperse Fe fine particles in the hard magnetic phase, thus producing a nanocomposite magnet. Japanese Patent Application Publication No. 2003-59708 (JP-A-2003-59708) says that by controlling the condition of the thermal treatment, a minute Fe phase is dispersed in the nanocomposite magnet.

However, the foregoing method has the following problem. That is, depending on the thermal treatment condition, the crystal grain of Fe becomes rough and large, and the method is not suitable for an industrial technique that requires large-volume synthesis.

### DISCLOSURE OF THE INVENTION

An object of the invention is to provide a method of producing a nanocomposite magnet that contains an Fe particle of an appropriate particle diameter.

A first aspect of the invention relates to a production method for a nanocomposite magnet having a core-shell structure that includes a hard magnetic phase of an Nd₂Fe₁₄B compound as a core, and a soft magnetic phase of Fe as a shell. In this production method, a particle of the Nd2Fe14B compound is added and dispersed in a solvent that contains a surface-active agent. Then, an Fe precursor is added into the solvent in which the particle of the Nd₂Fe₁₄B compound has been added, and an Fe particle is deposited on a surface of the particle of the Nd2Fe14B compound. Then, the particle of the Nd₂Fe₁₄B compound on which the Fe particle has deposited is dried and sintered.

In this production method, an amount of the Fe precursor added may be 1.0 to 3.0 mol %.

In this production method, the Fe particle may be deposited by reducing the Fe precursor.

The Fe precursor may be an iron acetylacetonate.

The Fe precursor may be reduced by using a polyol as a reducing agent.

The polyol may be at least one of 1,2-octanediol, 1,2-dodecanediol, 1,2-tetradecanediol and 1,2-hexadecanediol.

The solvent may have a temperature equal to or higher than 230° when the Fe precursor is reduced.

An amount of the reducing agent may be at least 1.5 times as large in molar ratio as the amount of the Fe precursor to be reduced.

The Fe particle may be deposited by thermally decomposing the Fe precursor.

The Fe precursor may be pentacarbonyliron.

A heating temperature in the thermal decomposition of the Fe precursor may be higher than or equal to 170° C.

The Fe precursor may be a salt of Fe.

The salt of Fe may be at least one of FeCl₃, FeSO₄, FeCl₂, Fe(OH)₃ and Fe(NO₃)₃.

The surface-active agent may be a sodium bis(2-ethylhexyl)sulfosuccinate, a polyethylene glycol hexadecyl ether or a polyethylene glycol nonylphenyl ether.

A diameter of the particle of the Nd₂Fe₁₄B compound may be 500 nm to 2 μm.

The sintering may be performed at 250 to 600° C.

The sintering may be performed under a hydrogen reduction atmosphere.

A technique of the sintering may be hot press or spark plasma sintering.

According to the invention, using an Nd₂Fe₁₄B compound particle as a core, a shell of Fe is formed by causing Fe to deposit from an Fe precursor on the surface of the Nd₂Fe₁₄B compound particle. Therefore, a high-performance magnet is composited to a nanoscale order can be obtained without making the Nd₂Fe₁₄B compound particle rough and large.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a schematic diagram of a nanocomposite magnet obtained through a method in accordance with the invention;

FIG. 2 is a TEM (Transmission Electron Microscope) photograph of Nd₂Fe₁₄B/Fe composite particles obtained in a working example of the invention; and

FIG. 3 is a graph showing a particle diameter distribution of Fe particles in the Nd₂Fe₁₄B/Fe composite particles obtained in the working example.

### DETAILED DESCRIPTION OF EMBODIMENTS

The production method for a nanocomposite magnet in accordance with the invention will be described in detail below. In the production method for a nanocomposite magnet in accordance with the invention, a particle of an Nd₂Fe₁₄B compound is added and dispersed in a solvent that contains an surface-active agent. The particle of the Nd₂Fe₁₄B compound can be obtained by pulverizing in a cutter mill an Nd₂Fe₁₄B amorphous ribbon produced in a single-roll furnace within a glove box. It is preferable that the particle diameter of the Nd₂Fe₁₄B compound particle be in an order of submicron, that is, in the range of 500 nm to 2 μm, in order to achieve the effect of the conjugation with the Fe shell that constitutes the soft magnetic phase. The particle of the Nd₂Fe₁₄B compound may be pulverized so as to have the aforementioned particle diameter before being added to the solvent, and may also be pulverized by a beads mill or the like after being added into a solvent.

It is also preferable that the solvent have a high boiling point since the solvent is heated when Fe is deposited after the aforementioned pulverization. For example, octyl ether, octadecene, squalene, tetraethylene glycol, triphenyl methane, etc., may be used as the solvent.

As the surface-active agent, oleylamine, oleic acid, tetraethylene glycol, etc., may be used. Due to the addition of the surface-active agent, the particle of the Nd₂Fe₁₄B compound can be maintained in a stably dispersed state in the solvent, and the aggregation of deposited Fe can be prevented.

After the particle of the Nd₂Fe₁₄B compound is added and dispersed in the solvent containing the surface-active agent, an Fe precursor is added into the solvent. It suffices that the Fe precursor may be a material that produces deposit of Fe due to reduction, thermal decomposition or the like. For example, iron acetylacetonate, pentacarbonyliron, a salt of Fe (e.g., FeCl₃, FeSO₄, FeCl₂, Fe(OH)₃, Fe(NO₃)₃.), etc. may be used as an FE precursor.

It is preferable that the amount of the Fe precursor added be 1.0 to 3.0 mol % with reference to the molar concentration of the Fe precursor present in the reaction solvent. The addition of the Fe precursor in an amount greater than 3.0 mol % sometimes results in the deposition of rough and large Fe particles, which is not appropriate as the soft magnetic phase of the nanocomposite magnet. On the other hand, if the amount of the Fe precursor added is less than 1.0 mol %, a shell sufficiently covering the surroundings of the particle of the Nd₂Fe₁₄B compound that forms the core sometimes cannot be formed.

After the Fe precursor is added, the particles of the Nd₂Fe₁₄B compound disposed in the solvent act as cores on whose surfaces Fe particles are deposited. In the case where iron acetylacetonate is used as the Fe precursor, Fe particles can be deposited through reduction since iron acetylacetonate dissolves in the aforementioned high-boiling point solvent and therefore the iron exists as ions. In this case, it is preferable to use a polyol as a reducing agent and perform polyol reduction. The polyols that can be used in this manner include 1,2-octanediol, 1,2-dodecanediol, 1,2-tetradecanediol, 1,2-hexadecanediol, etc.

In order to dissolve the Fe precursor and reduce the Fe precursor, it is preferable to heat the reaction system. In particular, in order to perform the reduction completely, it is preferable to heat the reaction system to or above 230° C. The heating time (reduction time) varies depending on the heating temperature, and is selected so as to sufficiently perform the reduction and cause Fe particles to deposit. It is preferable that the amount of the reducing agent added be at least 1.5 times as large in molar ratio as the added amount of the Fe precursor to be reduced.

In the case where pentacarbonyliron (Fe(CO)₅) is used as the Fe precursor, Fe particles can be deposited by thermally decomposing pentacarbonyliron. It is preferable that the heating temperature for the thermal decomposition be higher than or equal to 170° C.

In the case where a salt of Fe is used as the Fe precursor, Fe particles are deposited by forming reversed micelles of the salt of Fe and dispersing them in the solvent since the salt of Fe does not dissolve in organic solvents. Generally, while a micelle means a system in which an oil droplet is enclosed in a water phase due to the action of a surface-active agent, a reversed micelle means a system in which a water droplet is enclosed in an oil phase due to the employment of a surface-active agent, specifically, a system in which the salt of Fe is enclosed in the solvent by means of the surface-active agent. The surface-active agent that may be used herein include AOT (sodium bis(2-ethylhexyl)sulfosuccinate), polyethylene glycol hexadecyl ether, polyethylene glycol nonylphenyl ether, etc. which are commonly used to form reversed micelles. The solvent that may be used herein include isooctane, hexane, etc.

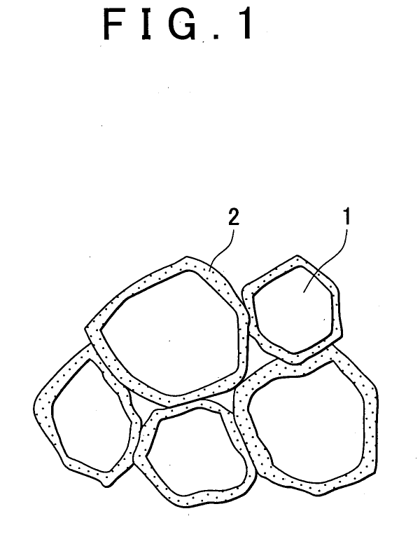

By causing Fe particles to deposit on particles of the Nd₂Fe₁₄B compound as described above, a core-shell structure having a particle 1 of the Nd₂Fe₁₄B compound as a core and a shell 2 that is formed of Fe particles on the surface of the particle 1 as shown in FIG. 1 is obtained.

The thus obtained particles are dried and sintered to obtain a nanocomposite magnet. It is preferable that the sintering be performed at a temperature (250 to 600° C.) which is immediately above the temperature that accelerates the self-diffusion of Fe and which is as low as possible in order to restrain the growth of the Fe particles that constitute shells. As for the sintering technique, it is preferable to perform SPS (Spark Plasma Sintering), hot press, etc., under a hydrogen reduction atmosphere.

An Nd₂Fe₁₄B amorphous ribbon prepared in a single-roll furnace in a glove box was pulverized using a cutter mill. The Nd₂Fe₁₄B pulverized by the cutter mill was added to a system formed by adding oleic acid and oleylamine into octyl ether, and was pulverized for 6 hours in a beads mill using beads of φ500 μm. 0.3 g of the thus obtained particles of Nd₂Fe₁₄B was added into a 4-neck flask together with 8 mL of oleic acid and 8.5 mL of oleylamine as a solvent.

Next, the amounts of iron acetylacetonate as shown in Table 1 below were added, and the mixtures were heated to 160° C., and uniform solutions were obtained. After the solutions were heated to 230° C. while being vigorously stirred, the amounts of hexadecanediol as shown in Table 1 were added, and then the mixtures were kept for 1 hour. Subsequently, the mixtures were cooled to the room temperature. After hexane was added to dissolve the amide, the solutions were kept at 30° C. in a bath to allow Nd₂Fe₁₄B/Fe composite particles to sediment. After the supernatant was removed, acetone was added to further sediment Nd₂Fe₁₄B/Fe composite particles. After this operation is repeated several times, centrifugal separation was performed, and the Nd₂Fe₁₄B/Fe composite particles were dried in a glove box.

TABLE 1
Experiment Conditions

| | Nd₂Fe₁₄B | Iron acetylacetonate | Hexadecanediol |
|---|---|---|---|
| Sample 1 | 0.3 g | 1.766 g (5.0 mmol, | 1.9400 g (7.50 mmol) |
| | | 9 mol %) | |
| Sample 2 | 0.3 g | 0.530 g (1.5 mmol, | 0.5815 g (2.25 mmol) |
| | | 2.9 mol %) | |
| Sample 3 | 0.3 g | 0.317 g (0.9 mmol, | 0.3489 g (1.35 mmol) |
| | | 1.7 mol %) | |
| Sample 4 | 0.3 g | 0.177 g (0.5 mmol, | 0.1938 g (0.75 mmol) |
| | | 1.0 mol %) | |

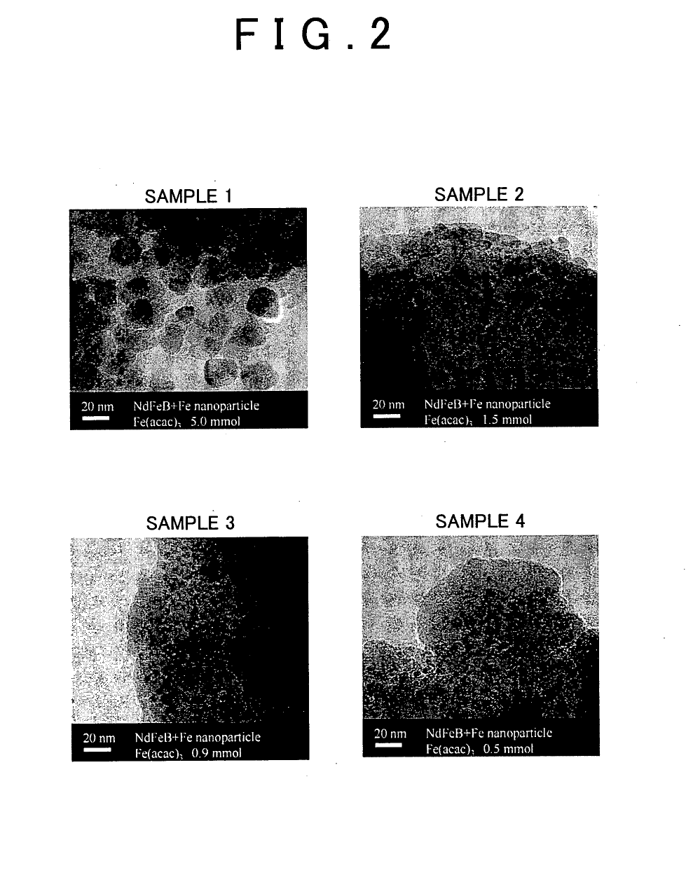

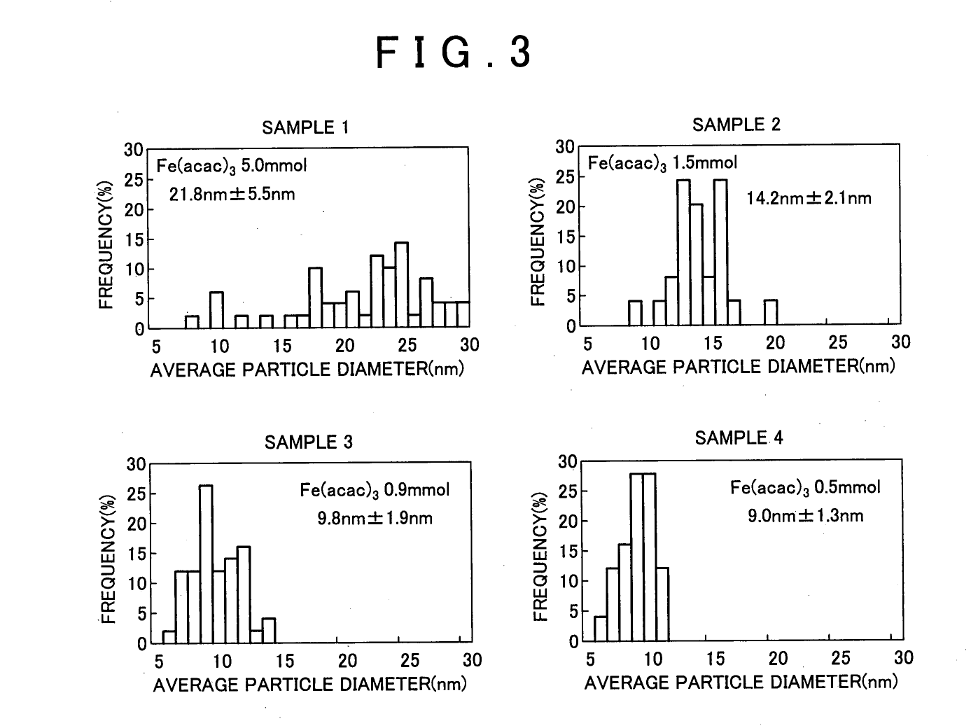

Results of the TEM observation of obtained samples are shown in FIG. 2. Besides, from the TEM images, the particle diameters of the generated Fe particles were measured. Results of the measurement are shown in FIG. 3. In any of the samples, the generation of spherical Fe nanoparticles of about 10 to 20 nm on Nd₂Fe₁₄B particles of the order of micron was recognized. However, in Sample 1, besides spherical particles, rough and large cube-shape particles also existed. In the other samples, only spherical particles of about 10 nm were recognized. In Sample 3, in particular, the average particle diameter was the closest to 10 nm, and the generation of Fe nanoparticles on Nd₂Fe₁₄B particles was also recognized.

While the invention has been described with reference to example embodiments thereof, it is to be understood that the invention is not limited to the described embodiments or constructions. On the other hand, the invention is intended to cover various modifications and equivalent arrangements. In addition, while the various elements of the disclosed invention are shown in various example combinations and configurations, other combinations and configurations, including more, less or only a single element, are also within the scope of the appended claims.

1. A production method for a nanocomposite magnet having a core-shell structure that includes a hard magnetic phase of an Nd₂Fe₁₄B compound as a core, and a soft magnetic phase of Fe as a shell, the production method comprising:
adding and dispersing a particle of the Nd₂Fe₁₄B compound in a solvent that contains a surface-active agent;
then adding an Fe precursor into the solvent in which the particle of the Nd₂Fe₁₄B compound has been added, and causing an Fe particle to deposit on a surface of the particle of the Nd₂Fe₁₄B compound; and
drying and sintering the particle of the Nd₂Fe₁₄B compound on which the Fe particle has deposited.

2. The production method according to claim 1, wherein an amount of the Fe precursor added is 1.0 to 3.0 mol %.

3. The production method according to claim 1, wherein the Fe particle is deposited by reducing the Fe precursor.

4. The production method according to claim 3, wherein the Fe precursor is an iron acetylacetonate.

5. The production method according to claim 3, wherein the Fe precursor is reduced by using a polyol as a reducing agent.

6. The production method according to claim 5, wherein the polyol is at least one of 1,2-octanediol, 1,2-dodecanediol, 1,2-tetradecanediol and 1,2-hexadecanediol.

7. The production method according to claim 3, wherein the solvent has a temperature equal to or higher than 230° when the Fe precursor is reduced.

8. The production method according to claim 5, wherein an amount of the reducing agent is at least 1.5 times as large in molar ratio as the amount of the Fe precursor to be reduced.

9. The production method according to claim 1, wherein the Fe particle is deposited by thermally decomposing the Fe precursor.

10. The production method according to claim 9, wherein the Fe precursor is pentacarbonyliron.

11. The production method according to claim 9, wherein a heating temperature in the thermal decomposition of the Fe precursor is higher than or equal to 170° C.

12. The production method according to claim 1, wherein the Fe precursor is a salt of Fe.

13. The production method according to claim 12, wherein the salt of Fe is at least one of FeCl₃, FeSO₄, FeCl₂, Fe(OH)₃ and Fe(NO₃)₃.

14. The production method according to claim 12, wherein the surface-active agent is at least one of a sodium bis(2-ethylhexyl)sulfosuccinate, a polyethylene glycol hexadecyl ether and a polyethylene glycol nonylphenyl ether.

15. The production method according to claim 1, wherein a diameter of the particle of the Nd₂Fe₁₄B compound is 500 nm to 2 μm.

16. The production method according to claim 1, wherein the sintering is performed at 250 to 600° C.

17. The production method according to claim 1, wherein the sintering is performed under a hydrogen reduction atmosphere.

18. The production method according to claim 17, wherein a technique of the sintering is hot press or spark plasma sintering.
